(19) United States
(12) Patent Application Publication
(10) Pub. No.: US 2023/0020432 A1
(43) Pub. Date: Jan. 19, 2023

(54) HERBICIDE SPOT SPRAYER

(71) Applicant: SPRAYER MODS, INC., Iowa City, IA (US)

(72) Inventors: Ethan BENNETT, Iowa City, IA (US); Blake ESPELAND, West Des Moines, IA (US); Benjamin LANGE, Iowa City, IA (US)

(21) Appl. No.: 17/867,428

(22) Filed: Jul. 18, 2022

Related U.S. Application Data
(60) Provisional application No. 63/223,221, filed on Jul. 19, 2021.

(51) Int. Cl. G06V 20/10; G06V 10/44; G06V 10/56; G06T 7/70; G06T 7/20; A01M 7/00

(52) U.S. Cl. CPC G06V 20/188; G06V 10/443; G06V 10/56; G06T 7/70; G06T 7/20; A01M 7/0089; G06T 2207/30188

(57) ABSTRACT

Providing an object detection engine, training the object detection engine to identify a weed, training the object detection engine to identify a crop, providing an image from a sensor to the object detection engine, discerning with the object detection engine the weed from the crop, and plotting a path from the weed to a spot spray assembly upon identification of the weed by the object detection engine.

### CROSS-REFERENCE TO RELATED APPLICATIONS

The present application claims the benefit of U.S. Provisional Application Ser. No. 63/223,221 filed Jul. 19, 2021, which is incorporated herein by reference.

### TECHNICAL FIELD

This disclosure relates to agricultural sprayers, and more specifically, this disclosure is directed to an agricultural spot-spraying system with advanced object recognition and tracking.

### BACKGROUND INFORMATION

Environmental and economic concerns are forcing agricultural producers to modify traditional practices to remain viable. Soil conservation, moisture conservation, and agricultural input costs are the primary concerns facing the North American agricultural producer.

In an attempt to ameliorate these problems, tractor-drawn sprayers, aerial application spraying, and even semi-automated techniques using unmanned vehicles have been used. In all such cases, however, the targeting is at best approximate, with significant quantities of over-application of costly agricultural chemicals being inevitably dispersed as either airborne droplets, or liquid run-off, with minimal impact on the target. This type of spraying is expensive, wasteful, and bad for the environment.

Accordingly, there is a need for an advanced object recognition and tracking system with precise time of arrival estimation for precise spot application of agricultural inputs.

### SUMMARY

Disclosed herein is a method for spraying a weed in a field. The method comprises providing an object detection engine, training the object detection engine to identify a weed, training the object detection engine to identify a crop, providing an image from a sensor to the object detection engine, discerning with the object detection engine the weed from the crop, and plotting a path from the weed to a spot spray assembly upon identification of the weed by the object detection engine.

In an embodiment, the step of discerning with the object detection engine the weed from the crop further comprises filtering the image to remove crops from the image and leave the weed or filtering the image further comprises filtering out the crops. The object detection engine can be configured for detecting green pixels in the image and discerning with the object detection engine crop rows on opposite sides of the weed. In instances where crop rows are detected, the method can comprise plotting a polynomial path along the crop rows, estimating a location of arrival to the spot spray assembly, and estimating a time of arrival of the spot spray assembly to the weed.

Alternatively, plotting the path from the weed to a spot spray assembly can comprise calculating a vector field of the image from the image sensor and calculating a time of arrival of the spot spray assembly to the weed. Next, the method can comprise calculating a location of arrival to the spot spray assembly.

In an alternative embodiment, a spot spraying system for applying material to an object in a field is disclosed. The system can comprise an image sensor, an object detection engine in communication with the sensor for receiving images from the image sensor, a library of tagged objects in communication with the object detection engine comprising images of objects and non-objects, wherein the object detection engine compares images from the image sensor with the images of objects and non-objects in the library of tagged objects to discern objects and non-objects wherein upon detection of the object a path of arrival and time of arrival is calculated, and a solenoid in communication with the object detection engine for opening a valve in response to the path of arrival and time of arrival.

In an embodiment, the object detection engine filters out images from the image sensor that contain crops. The object detection engine can also detect green pixels in the image corresponding to the weed and/or detect green pixels in the image corresponding to crop rows. The object detection engine can discern crop rows on opposite sides of the weed and calculate a polynomial path along the crop rows which is used to plot the path of arrival of the spray nozzle to the weed and its time of arrival.

In an embodiment, an optical flow engine is in communication with the image sensor for receiving images from the image sensor. The optical flow engine calculates a vector field from the image and calculates a time of arrival and the path of arrival to the spray nozzle or the solenoid controlling the spray nozzle or to the field of spray of a spray nozzle, such that the solenoid is opened when the object is in the field of spray of a nozzle combined to the sprayer.

### BRIEF DESCRIPTION OF THE DRAWINGS

These and other features and advantages of the present invention will be better understood by reading the following detailed description, taken together with the drawings wherein:

FIG. 1 is a plan view of a tractor pulling a spot spraying apparatus.

FIG. 2 is a functional block diagram of spot spraying apparatus.

FIG. 3 is a profile schematic vie of a camera and a spraying nozzle on the boom of FIG. 2.

FIG. 4 is a two-dimensional map of the field and spot spraying apparatus of FIG. 1.

FIG. 5 is a two-dimensional map of a polynomial path from the a spray nozzle to an object.

FIG. 6 is a flow chart for a method of spraying a weed in a field.

### DETAILED DESCRIPTION OF THE PREFERRED EMBODIMENTS

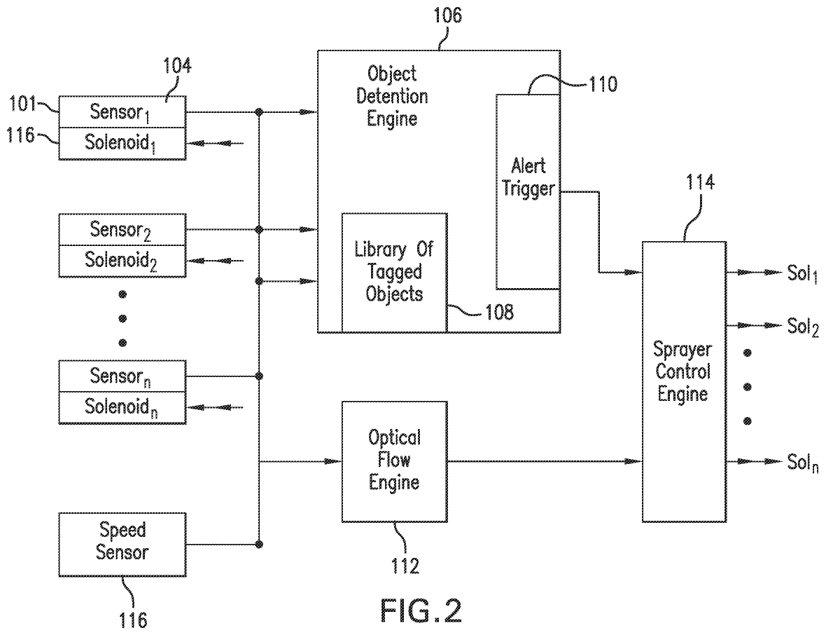

The present application is directed towards precise application of agricultural inputs to an object in a field by an applicator moving in a direction of travel over the ground. Agriculture inputs includes any solid or liquid capable of being stored in a reservoir for application to an object on the ground, such as herbicides, fungicides, pesticides, water, fertilizer, or seeds. The object on the ground can include, but is not limited to, particular types of plants, such as crops or weeds, or open areas in the ground where a seed may be required. The applicator can be installed on a land-based, operator controlled fertilizer spreader, or planter, or can be an installed on an unmanned land-based or aerial vehicle. For convenience, the following description will be directed to tractor-pulled spreader with a transverse boom, as illustrated in FIG. 2, with an object detector configured for identifying weeds 10 in a field of crops 9 and a spot spraying system 100 for precise application of herbicide to the weed.

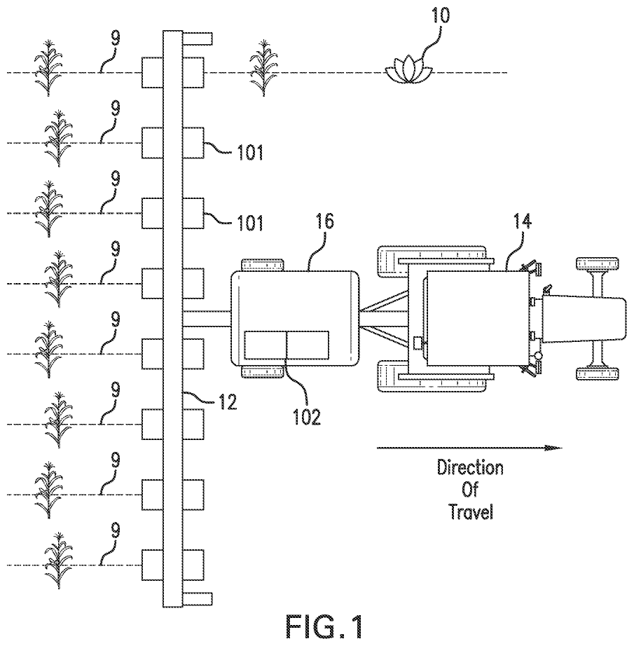

FIG. 1 shows spot spraying system 100 for applying material to weed 10 detected in a field of crops 9 as spot spraying system 100 travels in a direction of travel over the ground. Spot spraying system 100 comprises of one or more spot spray assemblies 101 combined to a boom 12 with each spot spray assembly 101 attached to a reservoir 16 in the form of a sprayer tank that is pulled by a tractor 14. Each spot spray assembly 101 on boom 12 may or may not be spaced apart to align with conventional distances between crop rows. Reservoir 16 provides herbicides through tubing to each spot spraying assembly 101. Power and communication signals come from a processor 102 connected to the power system of tractor 14.

FIG. 2 shows a functional block diagram of spot spraying system 100. Each spot spray assembly 101 can comprise of at least one sensor 104 for detecting weed 10 in the field. Sensor 104 can be implemented as a camera adapted to generate a 2-D image of the environment in the form of a standard rgb camera, thermal imaging camera, an infrared camera, or the like. Sensor 104 may also be enhanced using supplementary lighting systems, including for example LED, xenon, UV or IR light sources, operating in continuous, intermittent or strobed modes.

Signals from sensor 104 are communicated to an object detection engine 106 in processor 102. Images from the sensor 104 are recorded continuously and provided as input signals to object detection engine 106. In an embodiment, object detection engine 106 is implemented as an artificial intelligence (AI) module, also referred to as a machine learning or machine intelligence module, which may include a neural network (NN), e.g., a convolutional neural network (CNN), trained to identify an object or objects or discriminate between two similar looking objects. Object detection engine 106, for example, is trained to identify weed 10 and crop 9 and to differentiate between weed 10 and crop 9. It has been found that by training object detection engine 106 to identify weeds 10 and crops 9 that the object detection engine 106 is better able to discriminate between weeds 10 and crops 9. This is an improvement over merely training object detection engine 106 to identify one or the other and act or not act on the detection of the same. Any suitable AI method and/or neural network may be implemented, e.g., using known techniques. For example, a fully convolutional neural network for image recognition (also sound or other signal recognition) may be implemented using the Tensor Flow machine intelligence library.

Object detection engine 106 includes a library of tagged objects 108. In the illustrated embodiment, library of tagged objects 108 contains stored images of weeds 10 and crops 9 and categorized or tagged in a database as weeds 10 or crops 9. Object detection engine compares images from sensor 104 with the images of objects (weeds 10 and/or crops 9) and non-objects contained in library of tagged objects 108 to discern objects (weeds 10 and/or crops 9) and non-objects in the images. In other words, objection detection engine 106 uses library of tagged objects 108 to compare in real-time incoming images that contain weeds 10 and/or crops 9 in the form of input signals from sensor 104 that are recorded continuously and provided to object detection engine 106. Object detection engine 106 can filter out images or portions of images from sensor 104 that contain weeds 10 and/or crops 9 based on appearance and color of the pixels in the images. Object detection engine 106, for example, can be trained to detect green pixels in the images from sensor 104 to enhance detection of weeds 10 and/or crops 9.

Object detection engine 106 can used bounding boxes around objects and non-objects to discern whether the object is a weed or a crop or something else. The bounding box is a five vector output comprising an x, y location in the image with a height (h) and width (w) of the bounding box. The object or non-object in the bounding box is then compared with images in library of tagged objects 108 for identification as a weed 10 and/or crop 9 or something else. From this comparison, object detection engine 106 may provide a confidence level with respect to its determination that the object (e.g., weed 10 or crop 9) is present in the image from sensor 104. The confidence level is one of the five item vector output by the object detection engine 106: x, y, h, w component for a bounding box and the confidence level number. If the confidence level is below a preset threshold, then the bounding box is rejected as not being indicative of weed 10 or crop 9. When weed 10 is detected, an alert trigger 110 can be provided in object detection engine 106 to output an alert signal to sprayer control engine 114, or the alert can be sent directly to the appropriate spot spray assembly 101 when that is determined.

When objection detection engine 106 identifies the object, such as weed 10 for spraying, a path of arrival to the nearest spot spray assembly 101 and time of arrival must be calculated. The path of arrival can be calculated subsequent or simultaneous with the bounding boxes for the object detection engine 106. There are two ways for calculating path of arrival. First, using object detection engine 106, object detection engine 106 is trained to identify rows of crops 9 to discern rows on the opposite sides of weed 10 or discern a row of crops 9 nearest weed 10. Library of tagged objects 108 contains images of crops 9 categorized in as such in the database as the same. Objection detection engine 106 uses library of tagged objects 108 to compare in real-time incoming images that contain crops 9 in the form of input signals from sensor 104 that are recorded continuously and provided to object detection engine 106. Objection detection engine 106 uses bounding boxes with a five vector output comprising x, y, h, w components in the pixels of the image and a confidence level component above a threshold that is indicative of crop 9.

In other words, object detection engine 106 detects crops 9 based on a similar bounding box method as detecting weed 10. Object detection engine 106 can also identify a color, such as green, in the incoming images. So, when a bounding box with a crop 9 is detected, pixels in the image outside of bounding box for crop 9 are set to black. Then a line is fit using a polynomial path function on the remaining green or shades of green pixels to identify the row of crop 9.

The crop row path is used for determining the path of arrival and time of arrival in real time of the weed to the appropriate spot spray assembly 101. Two paths orthogonal to the crop rows that pass through the bottom corners of the bounding box of weed 10 are created and the X location of the Y intercept of these lines are used to determine which spot spray assembly 101 will intercept the weed. The location of arrival of weed 10 relative to spot spray assembly 101 of a plurality of spot spray assembly 101 can be determined from a two-dimensional x, y coordinate relative to the bounding box for weed 10 and the polynomial path. A speed signal obtained from a speed sensor 117 can be used to calculate the time of arrival of the detected object to the appropriate spot spray assembly 101. The delay or time of arrival can be calculated with an isometric projection of the ground, assuming the ground is flat, and calculate the length of the path to the weed by comparing it to the path row length. The length can be divided by the current speed from speed sensor 117 to get the time at which the weed 10 should be sprayed. This calculation takes into account the time for spray to travel from the nozzle of spot spray assembly 101 to the ground and time the nozzle takes to open subtracted from them, and then are both recorded as the time to open the nozzle of spot spray assembly 101.

The second way for calculating the path of arrival to the nearest spot spray assembly 101 and time of arrival is with an optical flow engine 112. In this implementation, signals from sensor 104 are communicated to optical flow engine 112 in processor 102. Images from the sensor 104 are recorded continuously and provided as input signals to optical flow engine 112. Optical flow engine 112 determines the direction each pixel is moving by, for example, creating a vector field with units change in pixels per frame with X and Y components. Two two-variable polynomials are fit to this vector field to make it continuous.

With a continuous vector field created, optical flow engine 112 generates a path across this vector field. The path can be generated using Euler's method of approximating the path of a solution curve, i.e., where in the X-axis the weed will end up. The X location of this path's intersection with the Y axis is used to determine the corresponding spot spray assembly 101 in which the object i.e., weed is aligned. The length of the path (which is in frames) is divided by the frame rate in frames per second or speed signal from speed sensor 117 to give the timing interval in which the weed within the field of spray of spot spray assembly 101. In an embodiment, containing a succession of incoming images from sensor 104 where each image is a frame (N) where n is an integer: for frame (N−1) and frame (N), optical flow engine 112 generates a discrete vector field “O” with O(x, y)=(Δx, Δy) the velocity of pixel x, y in pixels/second. Fit two polynomials, Pₓ and P_{y} to O(x, y) where Pₓ is a two variable polynomial such that Pₓ(x, y)≅O(x, y)ₓ and P_{y} is a two variable polynomial such that P_{y}(x, y)≅O(x, y)_{y}. Finally, when a weed is detected at x₁, y₁, let

(xₙ,yₙ)=(xₙ₋₁+Δt*Pₓ(xₙ₋₁,yₙ₋₁),yₙ₋₁+Δt*P_{y}(xₙ₋₁,yₙ₋₁)))

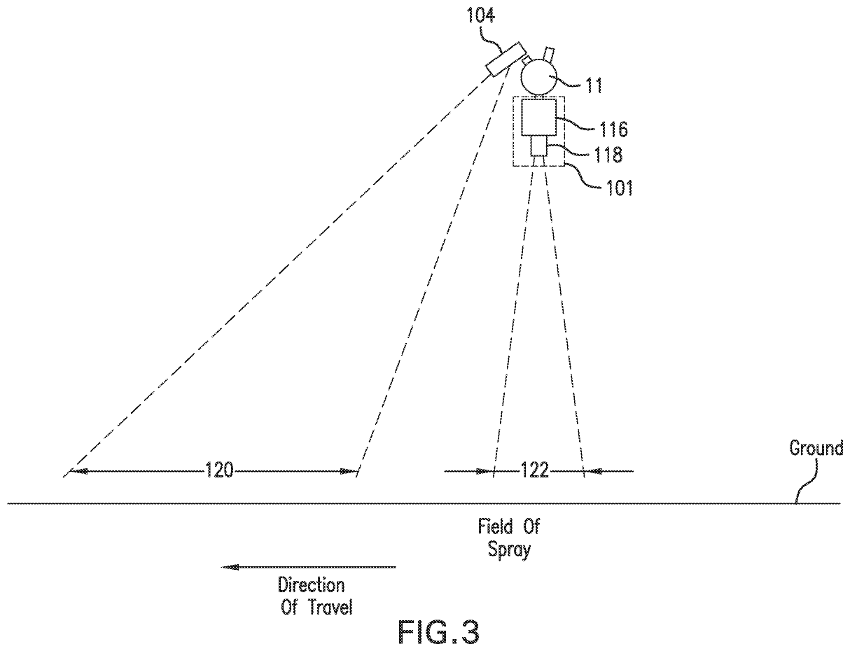

for n>1 and repeat till yₙ≤0. If n is minimal such that yₙ≤0, then let the xₙ be the x location of the y intercept used for determining which solenoid of the corresponding spot spray assembly 101 to actuate and Δt*n be the time of arrival of the weed. This will become apparent in the context of FIGS. 3-5.

FIG. 3 is a profile schematic of sensor 104 with spot spray assembly 101 on sprayer boom 11. Sensor 104 has a field of view 120 in which to detect objects and spot spray apparatus implemented with a solenoid controlled valve 116 to open the flow of agricultural inputs out a spray nozzle 118, which has a field of spray 122. A solution curve representing the path of arrival of an object in field of view 120 to field of spray 122 is generated by either objection detection engine 106 or optical flow engine 112 in the manner described above. At the appropriate time, sprayer control engine 114 in processor 102 activates corresponding solenoid controlled valve 116 to spray the weed.

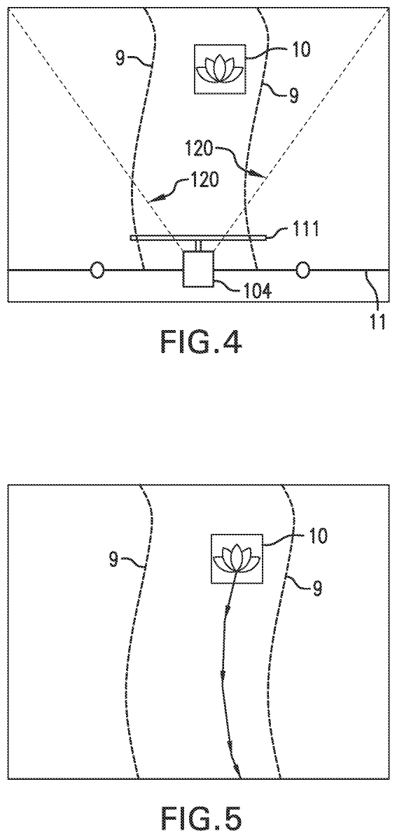

Fuming to FIG. 4, shown is a 2-D aerial view of spot spraying system 100 in the field. Spot spraying system 100 with two or more spot spray assembly 101 traverses in a forward direction of travel across a field with at least two rows of crops 9. The spot spray assembly 101 does not necessarily align with the crop rows and the weed 10 may or may not be in the crop row. A central sensor 104 may be centrally located on spot spraying system 100 with a field of view 120 forward of spot spraying system 100.

Turning to FIG. 5, shown is the field of view of sensor 104. In the manner described above with respect to optical flow engine 112, a best-fit polynomial path is plotted from the weed to the sprayer nozzle of spot spray assembly 101. From this, sprayer control engine 114 can determine which solenoid controlled valve 116 of spot spray assembly 101 must be activated and the time of arrival of the weed in the field of spray. Where weed 10 is detected between crop rows 9 in field of view 120 of sensor 104 where, for example, weed 10 is calculated to be at location:

x₁, y₁=(400,400)

The polynomial path at successive points towards sensor 104 and field of spray 122 are

x₂,y₂=(y₁₊Δt*Pₓ(x₁,y₁),y₁₊Δt*P_{y}(x₁,y₁))

x₃,y₃=(y₂₊Δt*Pₓ(x₂,y₂),y₂₊Δt*P_{y}(x₂,y₂))

x₄,y₄=(y₃₊Δt*Pₓ(x₃,y₃),y₃₊Δt*P_{y}(x₃,y₃))

The foregoing defines the path of arrival to spot spray assembly 101 and the time of arrival according to the manners described above.

In summary, sensors 104 implemented as cameras mounted on sprayer boom 12 are used to film the ground in front of spot spraying system 100. Images from these sensors 104 are fed to object detection engine 106 to locate the position of the weeds 10. Object detection engine 106 is then used to estimate the time of arrival of the weed 10 at the bottom of the image frame. Object detection engine 106 then estimates the path from the weed 10 to a field of spray of a corresponding sprayer nozzles. A signal is sent by processor 102 to an Ethernet relay of solenoid controlled valve 116 to open to apply herbicide to the weed 10 as it passes under the nozzle in the field of spray.

Those skilled in the art will recognize that the systems, engines, and devices described herein can be implemented as physical systems, engines, or devices, or implemented in software, or implemented in a combination thereof. Processor 102 can comprise a general processing unit (GPU) connected to the power system of the spot spraying system 100. The GPU can comprise software implemented object detection engine 106, optical flow engine 112, and sprayer control engine 114, or a combination of the foregoing. The GPU can connect to an Ethernet switch by Ethernet, which has Ethernet cables attached to each sensor 104 and controlled valve 116. The GPU can send open valve signals to controlled valve 116 through the Ethernet switch. The GPU can also receive video from sensors 104 through the Ethernet switch. Sensors 104 are attached to the Ethernet switch by Ethernet cabling that also can provide power. Sensors 104 can be mounted on sprayer boom 11, elevated, and face forward. Solenoid controlled valves 116 can also be mounted on the sprayer boom 11, as shown in FIG. 3. Piping from reservoir 16 can be attached to the input side of controlled valve 116 input with the output piping out a nozzle.

In an embodiment, solenoid controlled valve 116 can have a normally open solenoid vale. When controlled valve 116 is powered, the valve closes and to prevent liquid from exiting the attached nozzles. When it is not powered, liquid exits the attached nozzles. Solenoid controlled valve 116, as described above, can be connected to the sprayer's power through the Ethernet relay. The Ethernet relay can be connected to the sprayer's power and to the Ethernet switch through an Ethernet cable. When the Ethernet relay receives a spray signal, it does not output power to controlled valve 116. When the Ethernet relay receives a close signal, it outputs power to controlled valve 116.

Spot spraying system 100 herein described can use convolutional neural networks and other object detection engines to detect the presence and location of weeds in crop or fallow field for the purpose of spot-spraying the weed. Spot spraying system 100 uses these positions to schedule the application of any chemical to the weed with optical flow or the length along the crop row. Forward-facing sensors 104 implemented as cameras with an object detection engine 106 and tracking either by the object detection engine 106 or by the optical flow engine 112 calculates the time or distance from the weed to sprayer. Spot spraying system 100 uses an estimated path of the weed across the image frame to assign the weed to a nozzle of a number of nozzles corresponding to the number of spot spray assemblies 101 to spray the weed and the time to spray a weed.

In an embodiment, a single sensor 104 can cover multiple adjacent spot spray assemblies 101. Referring back to FIG. 4, in such embodiments, an indicator 111 can be physically mounted next to sensor 104, including above or below, such that it is configured to extend outward and perpendicular with the direction of travel so that the transverse portion of indicator 111 is in the field of view of sensor 104. Sensor 104 detects lines of demarcation along the transverse portion of indicator 111 with the mid-point being aligned with sensor 104. Object detection engine 106 sets dividing lines at the midpoints of the X value in the frame of these indicators, with those lines used to determine which spray nozzle 118 of solenoid control valve 116 should be opened so that the a field of spray will align with the weed 10 to apply herbicide given its X coordinate. This allows one sensor 104 to cover multiple nozzles 118 of corresponding solenoid controlled valves 116 or on boom 12 with different spacing for spray nozzles 118.

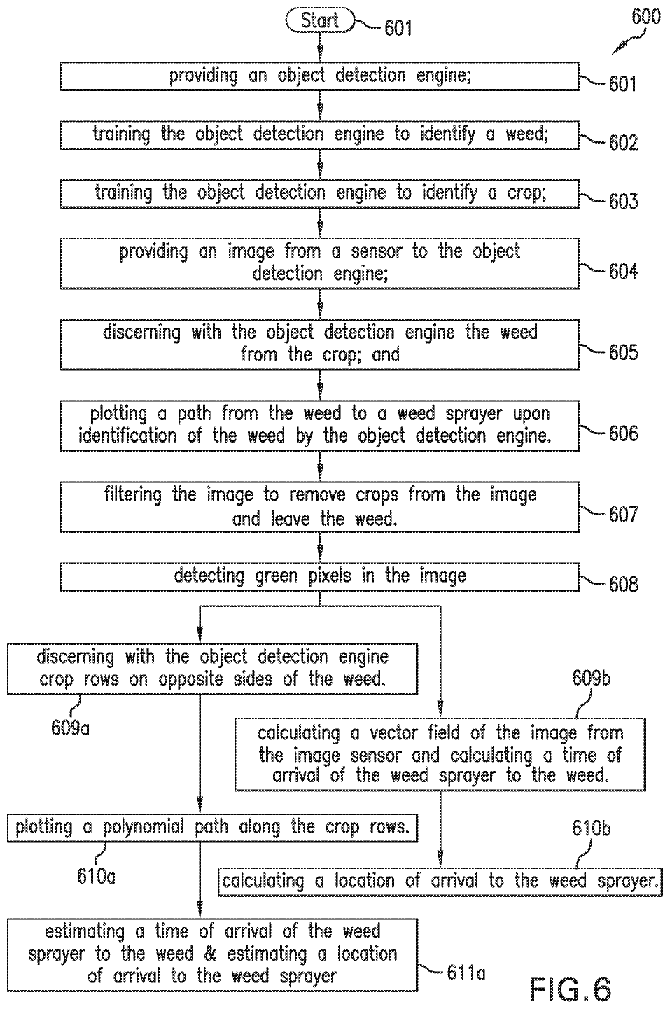

In an embodiment, a method 600 is disclosed, as shown in FIG. 6. Once the method begins, at step 601 the method comprises providing an object detection engine, the method continues at step 602 by training the object detection engine to identify a weed. The method continues at step 603 by training the object detection engine to identify a crop. The method continues at step 604 by providing an image from a sensor to the object detection engine. The method continues at step 605 by discerning with the object detection engine the weed from the crop. The method continues at step 606 by plotting a path from the weed to a spot spray assembly upon identification of the weed by the object detection engine. The method continues at step 607 by filtering the image to remove crops from the image and leave the weed. The method continues at step 608 by detecting green pixels in the image. The method continues in one of two ways.

The method can continue at step 609a by discerning with the object detection engine crop rows on opposite sides of the weed. The method continues at step 610a by plotting a polynomial path along the crop rows. The method continues at step 611a by estimating a time of arrival of the spot spray assembly to the weed and estimating a location of arrival to the spot spray assembly.

Alternatively, the method can continue at step 609b by calculating a vector field of the image from the image sensor and calculating a time of arrival of the spot spray assembly to the weed. The method continues at step 610b by calculating a location of arrival to the spot spray assembly.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

We claim:

1. A method for spraying a weed in a field, the method comprising:
providing an object detection engine;
training the object detection engine to identify a weed;
training the object detection engine to identify a crop;
providing an image from a sensor to the object detection engine;
discerning with the object detection engine the weed from the crop; and
plotting a path from the weed to a spot spray assembly upon identification of the weed by the object detection engine.

2. The method of claim 1, wherein the step of discerning with the object detection engine the weed from the crop further comprises filtering the image to remove crops from the image and leave the weed.

3. The method of claim 2, wherein the step of filtering the image further comprises filtering out the crops.

4. The method of claim 2, further comprising detecting green pixels in the image.

5. The method of claim 4, wherein plotting the path from the weed to a spot spray assembly further comprises discerning with the object detection engine crop rows on opposite sides of the weed.

6. The method of claim 5, and further comprising plotting a polynomial path along the crop rows.

7. The method of claim 6, and further comprising determining a location of arrival of the weed to the spot spray assembly of a plurality of spot spray assemblies from a two-dimensional x, y coordinate relative to a bounding box for the weed and the polynomial path.

8. The method of claim 6, and further comprising estimating a time of arrival of the spot spray assembly to the weed.

9. The method of claim 4, wherein plotting the path from the weed to a spot spray assembly further comprises calculating a vector field of the image from the image sensor and calculating a time of arrival of the spot spray assembly to the weed.

10. The method of claim 9, and further comprising calculating a location of arrival to the spot spray assembly.

11. A spot spraying system for applying material to an object in a field, the system comprising:
an image sensor;
an object detection engine in communication with the sensor for receiving images from the image sensor;
a library of tagged objects in communication with the object detection engine comprising images of objects and non-objects, wherein the object detection engine compares images from the image sensor with the images of objects and non-objects in the library of tagged objects to discern objects and non-objects wherein upon detection of the object a path of arrival and time of arrival is calculated; and
a spot spray assembly comprising a solenoid controlled valve in communication with the object detection engine for opening in response to the path of arrival and time of arrival.

12. The spot spraying system of claim 11, wherein the object detection engine filters out images from the image sensor that contain crops.

13. The spot spraying system of claim 12, wherein the object detection engine detects green pixels in the image corresponding to a weed.

14. The spot spraying system of claim 11, wherein the object detection engine discerns crop rows on opposite sides of a weed.

15. The spot spraying system of claim 14, wherein the object detection engine calculates a polynomial path along the crop rows and determines a location of arrival of the weed with respect the spot spray assembly of a plurality of spot spray assemblies from a two-dimensional x, y coordinate relative to a bounding box for the weed and the polynomial path.

16. The spot spraying system of claim 13, and further comprising an optical flow engine in communication with the image sensor for receiving images from the image sensor.

17. The spot spraying system of claim 16, wherein the optical flow engine calculates a vector field from the image and calculates a time of arrival and the path of arrival to the solenoid.

18. The spot spraying system of claim 17, wherein the solenoid is opened when the object is in a field of spray of the valve.

19. The spot spraying system of claim 11, wherein the objects are weeds and the non-objects are crops.

20. The spot spraying system of claim 11, and further comprising
a plurality of solenoid controlled valves each of which having a field of spray; and
an indicator combined to the sensor having a transverse portion with a midpoint aligned with the sensor and with lines of demarcation on opposite of the sensor and extending into a field of view of the sensor, wherein the object detection engine detects the lines of demarcation on the transverse portion of the indicator and determines which line of demarcation of the lines of demarcation aligns with the spot spray assembly having the field of spray that aligns with a weed.
